(19) United States
(12) Patent Application Publication
(10) Pub. No.: US 2012/0262874 A1
(43) Pub. Date: Oct. 18, 2012

(54) MOTHERBOARD AND SERVER USING THE SAME

(75) Inventors: ZHENG-HENG SUN, Tu-Cheng (TW); KANG WU, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/097,102

(22) Filed: Apr. 29, 2011

(30) Foreign Application Priority Data
Apr. 18, 2011 (CN) 201110096227.7

(51) Int. Cl. G06F 1/16

(52) U.S. Cl. 361/679.33

(57) ABSTRACT

A motherboard includes a switching circuit, a serial advanced technology attachment (SATA) connector, and a peripheral component interconnect x16 (PCIEx16) connector. The switching circuit is connected to the SATA connector and the PCIEx16 connector. The PCIEx16 is also connected to a serial attached small computer system interface (SCSI) (SAS) card. The switching circuit is disconnected from the PCIEx16 connector if a SATA hard disk drive (HDD) is connected to the SATA connector. The motherboard communicates with the SATA HDD through the switching circuit and the SATA connector. The switching circuit is connected to the PCIEx16 connector if the SATA connector is connected to an SAS HDD. The motherboard communicates with the SAS HDD through the SATA connector, the switching circuit, the PCIEx16 connector, and the SAS card.

### CROSS-REFERENCE OF RELATED APPLIOCATIONS

Relevant subject matter is disclosed in a pending U.S. patent application with application Ser. No. 13/095,904, filed on Apr. 28, 2011 and having a same title, which are assigned to the same assignee as this patent application.

### BACKGROUND

1. Technical Field

The present disclosure relates to motherboards, and particularly relates to a motherboard for supporting different types of hard disk drives (HDDs) and a server using the motherboard.

2. Description of Related Art

A serial attached small computer system interface (SCSI) (SAS) hard disk drive (HDD) can function as a selection or expansion storage device of a server. However, when a server supporting only a serial advanced technology attachment (SATA) needs to support an SAS HDD, an SAS card is needed to be connected to the SAS HDD through an SAS cable. Due to the SAS cable being a thick cable, when the SAS card is located far from the SAS HDD, the SAS cable will occupy much space of the server and hinder effective heat dissipating and assembling the server. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of a server.

FIG. 2 is an exploded, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

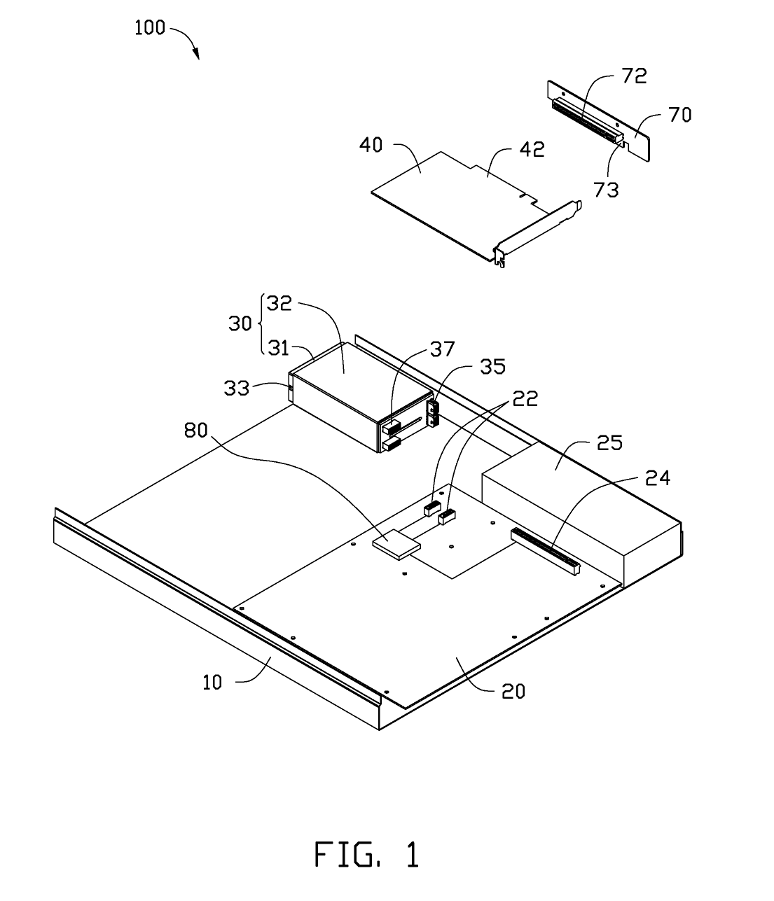

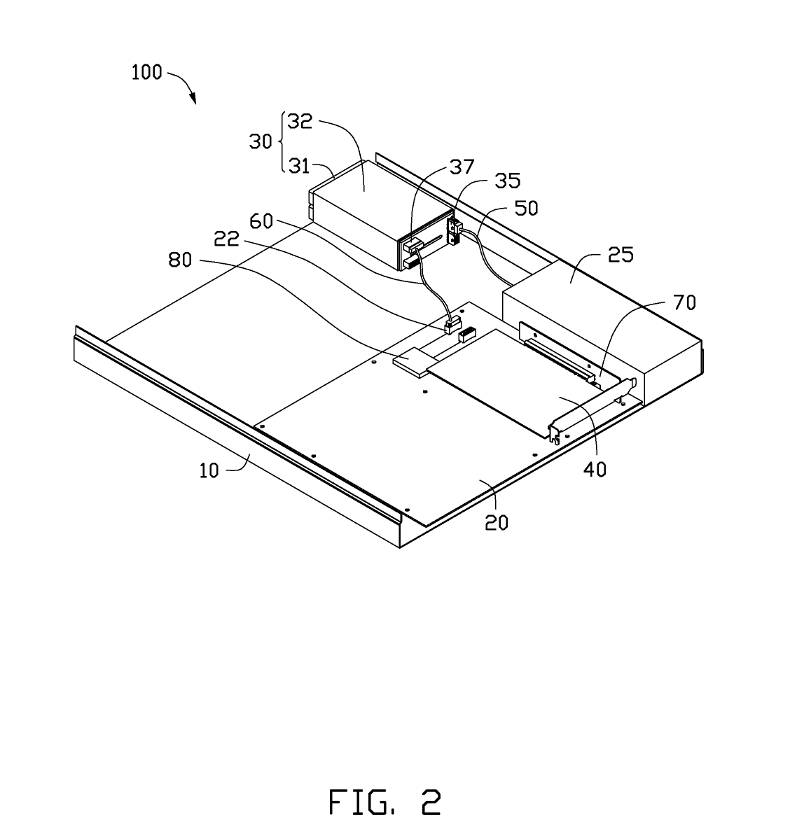

Referring to FIGS. 1 and 2, an exemplary embodiment of a server 100 includes a chassis 10, a motherboard 20, a power supply 25, a hard disk drive (HDD) unit 30 electrically connected to the power supply 25 through cables 50, a serial attached small computer system interface (SCSI) (SAS) card 40, and an adapter board 70. The motherboard 20, power supply 25, HDD unit 30, and SAS card 40 are all arranged in the chassis 10. In one embodiment, the adapter board 70 includes a plurality of first peripheral component interconnection express x16 (PCIEx16) golden fingers 73 and a PCIEx16 connector 72. The SAS card 40 includes a plurality of second PCIEx16 golden fingers 42.

The HDD unit 30 includes a box-shaped housing 32 and a plurality of HDDs 31 arranged in the housing 32. The housing 32 is fixed at a front portion of the chassis 10, and defines an opening 33 in a front end of the housing 32 through which the HDDs 31 are received. The HDDs 31 may be serial advance technology attachment (SATA) HDDs or SAS HDDs. Each HDD 31 includes a power interface 35 and a data interface 37 both located at a rear end of the HDD 31 opposite to the opening 33. If the HDD 31 is a SATA HDD, and the data interface 37 is a SATA interface, and the HDD 31 is an SAS HDD, then the data interface 37 is an SAS interface.

The circuit board 20 is arranged on a bottom wall of the chassis 10. The circuit board 20 includes a plurality of SATA connectors 22 for being connected to the data interfaces 37 of the HDDs 31, a switching circuit 80, and a PCIEx16 connector 24. The SAS card 40 is configured to convert signals between the motherboard 20 and the SAS HDD 31. The SAS card 40 is inserted into the connector 72 of the adapter board 70 through the golden fingers 42 of the SAS card 40. The adapter board 70 is inserted into the PCIEx16 connector 24 of the motherboard 20 through the golden fingers 73 of the adapter board 70. The switching circuit 80 is connected between the SATA connectors 22 and the PCIEx16 connector 24 of the motherboard 20. In one embodiment, the SAS card 40 can be electrically connected to the PCIEx16 connector 24 directly through the golden fingers 42 to save money.

If the HDD 31 is an SATA HDD, then the data interface 37 (e.g. an SATA interface) is connected to the corresponding SATA connector 22 of the motherboard 20 through a SATA cable 60. The server 100 is then powered on. The switching circuit 80 receives an SATA signal from the SATA HDD 31 through the SATA connector 22 and the SATA cable 60, and is disconnected from the PCIEx16 connector 24 of the motherboard 20. Thus, the motherboard 20 communicates with the SATA HDD 31 through the switching circuit 80 and the SATA connector 22.

If the HDD 31 is an SAS HDD, the data interface 37 (e.g. an SAS interface) of the SAS HDD 31 is connected to the corresponding SATA connector 22 of the motherboard 20 through the SATA cable 60, which is compatible with an SAS connector. The server 100 is then powered on. The switching circuit 80 receives SAS signals from the SAS HDD 31 through the SATA connector 22 and the SATA cable 60. If the HDD 31 is an SAS HDD, the switching circuit 80 is connected to the PCIEx16 connector 24 of the motherboard 20, to communicate with the SAS card 40 through the PCIEx16 connector 24, thus, the SAS

HDD 31 can communicate with the motherboard 20.

The motherboard 20 communicates with the SAS HDD 31 through connecting the PCIEx16 connector 24 and the switching circuit 80, thus, the SAS card 40 is electrically connected to the SAS HDD 31 through the SAS card 40 and the switching circuit 80, to make the SAS HDD 31 communicate with the motherboard 20. The motherboard 20 and the server 100 using the motherboard 20 can replace the SAS cables with the SATA cables when the motherboard 20 supports the SAS HDD 31.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A motherboard, comprising:
a serial advance technology attachment (SATA) connector operable to be connected to a hard disk drive (HDD);
a peripheral component interconnection express x16 (PCIEx16) connector operable to be connected to a serial attached small computer system interface (SCSI) (SAS) card; and
a switching circuit connected to the SATA connector and the PCIEx16 connector;
wherein if the HDD is a SATA HDD, the switching circuit is disconnected from the PCIEx16 connector, the motherboard communicates with the SATA HDD through the switching circuit and the SATA connector; if the HDD is an SAS HDD, the switching circuit is connected to the PCIEx16 connector, the motherboard communicates with the SAS HDD through the SATA connector, the switching circuit, the PCIEx16 connector, and the SAS card.

2. The motherboard as claimed in claim 1, wherein the SATA connector of the motherboard is connected to the HDD through an SATA cable.

3. A server, comprising:
a chassis;
a hard disk drives (HDDs) arranged in the chassis, and comprising a power interface and a data interface;
a power supply connected to the power interface of the HDD;
a serial attached small computer system interface (SCSI) (SAS) card comprising a plurality of peripheral component interconnection express x16 (PCIEx16) golden fingers; and
a motherboard comprising:
a serial advance technology attachment (SATA) connector connected to the data interface of the HDD;
a PCIEx16 connector connected to the PCIEx16 golden fingers of the SAS card; and
a switching circuit connected to the SATA connector and the PCIEx16 connector;
wherein if the HDD is an SATA HDD, the switching circuit is disconnected from the PCIEx16 connector, the motherboard communicates with the SATA HDD through the switching circuit and the SATA connector; if the HDD is an SAS HDD, the switching circuit is connected to the PCIEx16 connector, the motherboard communicates with the SAS HDD through the SATA connector, the switching circuit, the PCIEx16 connector, and the SAS card.

4. The server as claimed in claim 3, wherein the SAS card is electrically connected to the PCIEx16 connector of the motherboard through an adapter board, the adapter board comprises a plurality of PCIEx16 golden fingers and a PCIEx16 connector, the SAS card is inserted into the PCIEx16 connector of the adapter board, the golden fingers of the adapter board is inserted into the PCIEx16 connector of the motherboard.

5. The server as claimed in claim 3, wherein the data interface of the HDD is connected to the SATA connector of the motherboard through an SATA cable.
